(19) United States
(12) Patent Application Publication
(10) Pub. No.: US 2026/0039034 A1
(43) Pub. Date: Feb. 5, 2026

(54) U-Shaped Electrically Conductive Cross Brick

(71) Applicant: Electrified Thermal Solutions, Inc., Medford, MA (US)

(72) Inventors: Munevver Elif Asar Sarikaya, Newton, MA (US); Kwadwo Sarpong, Everett, MA (US)

(21) Appl. No.: 19/287,258

(22) Filed: Jul. 31, 2025

Related U.S. Application Data
(60) Provisional application No. 63/677,894, filed on Jul. 31, 2024.

(51) Int. Cl. H01R 4/58; H05B 3/62

(52) U.S. Cl. CPC H01R 4/58; H05B 3/62

(57) ABSTRACT

In a component (1) with a layered structure, at least one heat-conducting layer (5) is provided, in which a conducting element (2) intended to receive a heat-conducting medium is accommodated. A heat storage layer (3) adjoins the heat conducting layer (5), wherein the heat storage layer (3) comprises a natural stone. The conducting element (2) is accommodated in the heat-conducting layer (5) in a heat transfer element (5′), wherein the heat transfer element (5′) consists essentially of a powdered natural stone. The building element (1) is prefabricated in a production facility before it is transported to a construction site by connecting, preferably gluing, a heat-conducting layer (5), in which a conducting element (2) receiving a heat-conducting medium is accommodated in a heat transfer element (5′) consisting essentially of a powdered natural stone, on one broad side to a heat storage layer (3) made of a natural stone and on the opposite broad side to a supporting and/or insulating layer (4; 9).

### CROSS-REFERENCE TO RELATED APPLICATIONS

This application claims the benefit of U.S. Provisional Application No. 63/677,894, filed Jul. 31, 2024, the disclosure of which is hereby incorporated by reference in its entirety.

This application incorporates by reference, in their entireties, each of the following related and commonly owned non-provisional applications filed on even date herewith and having the following titles: Gas Turbine with an Electrically Heated Thermal Energy Storage System, U.S. application Ser. No. 18/790,901; Chromium Electrodes to Deliver Electric Power to Oxide Brick Circuits, U.S. application Ser. No. 18/791,024; Ceramic-Metal Composites for Use as Heating Elements for Electrified Resistance Heating and Thermal Energy Storage Systems, U.S. application Ser. No. 18/790,995; and Electrically Conductive Brickwork Module for Use as a Heating and/or Thermal Storage System, U.S. application Ser. No. 18/790,819.

This application also incorporates by reference, in its entirety, the following provisional patent application filed on even date herewith and having the following title: Modulating Electrical Resistance along a Column of E-Bricks, U.S. Provisional Application No. 63/677,824.

### TECHNICAL FIELD

The present invention relates to electrically conductive bricks and more particularly to a U-shaped design for an electrically conductive cross brick for physically and electrically connecting columns of electrically conductive bricks for use in electrified direct resistance heating and thermal energy storage systems.

### BACKGROUND ART

Traditional firebricks are a type of brick designed to insulate heat and withstand high temperatures, with common applications including lining furnaces, kilns, and chimneys. Electrically conductive firebrick systems combine this traditional heat-withstanding quality with electrical conductivity to enable thermal heating and storage solutions capable of reaching temperatures in the 1000° C. to 200C or higher and reliably cycling between a predetermined temperature range (e.g. ^{˜}1000° C. to ^{˜}1800° C.) on a daily basis without requiring the burning of fossil fuels. In such systems air/gas may be flowed through the firebrick system to extract the heat for various uses, including for use in industrial processes.

One such firebrick system is described in U.S. Pat. No. 11,877,376. In the disclosed firebrick system, air/gas flows straight over the conductive bricks. In the case of chromium oxide bricks, which may be used in this system, it has been found that the chromium oxide volatilizes, which erodes the brick's electrical performance over time, and also produces a toxic gas (CrO3) that must be kept below regulated levels and as low as possible.

U.S. Publication No. 2025/0052516 discloses an electrically conductive brickwork module configured to be used in an electrically heated thermal energy storage system and/or a resistive heating system to heat a fluid flowing across a dimension of the electrically conductive brickwork module from an input to an output. The module includes a plurality of electrically interconnected sets of electrically conductive bricks (E-Bricks) configured to be heated when electricity flows there through and a plurality of electrically insulating bricks separating each pair of adjacent sets of the plurality of electrically interconnected sets.

### SUMMARY OF THE EMBODIMENTS

In accordance with one embodiment, the disclosure provides an electrically conductive firebrick connector comprising: a base having a bottom surface configured to support the firebrick connector when placed on a flat surface; a first cylindrical protrusion having a first end extending away from the base on a first lateral side of the base and a second end configured to be connected to a cylindrically shaped firebrick; wherein the first cylindrical protrusion comprises an electrically conductive firebrick material; and a second cylindrical protrusion having a first end extending away from the base on a second lateral side of the base and a second end configured to be connected to another cylindrically shaped firebrick; wherein the second cylindrical protrusion comprises an electrically conductive firebrick material; wherein the first and second cylindrical protrusions are connected to each other by a concave electrically conductive firebrick structure forming part of the base. The entire connector may be formed of electrically conductive firebrick material.

In some aspects, the concave electrically conductive firebrick structure and the first and second cylindrical protrusions form a U-shape.

In some aspects, a cross-section of the base parallel to the bottom surface is obround. The bottom surface may include a centrally located arched portion extending into the base relative to the bottom surface. In other aspects, the bottom surface may be substantially flat. The bottom surface may be obround shaped. In still other aspects, the bottom surface may include an indented surface portion. The indented surface portion may be oval-shaped.

In some aspects of the disclosure, the bottom surface includes a first cylinder-shaped footing on the first lateral side of the base and a second cylinder-shaped footing on the second lateral side of the base; and wherein the first footing and the second footing extend away from the base in a direction opposite the first and second cylindrical protrusions. The first cylinder-shaped footing and the second cylinder-shaped footing may each have a first end located at a position on the base proximate the concave electrically conductive firebrick structure; and wherein the first ends of the first and second cylinder-shaped footing each extend laterally away from the base and are flared along their lengths from the first ends to their second ends terminating proximate the bottom surface.

In some aspects, the shape of the second ends of the first cylinder-shaped footing and the second cylinder-shaped footing are one of (a) circular in shape or (b) form a major arc of a circle. The second ends of first cylinder shaped footing and the second cylinder shaped footing may be one of (i) flush with the bottom surface or (ii) extend away from the bottom surface in a direction opposite the first and second cylindrical protrusions.

### BRIEF DESCRIPTION OF THE DRAWINGS

The foregoing features of embodiments will be more readily understood by reference to the following detailed description, taken with reference to the accompanying drawings, in which:

FIG. 1 provides a perspective view of an exemplary E-TESS system according to an aspect of this disclosure.

FIG. 2 provides a cross-sectional view of the exemplary E-TESS system of FIG. 1.

FIG. 3 provides a perspective view of an exemplary electrically conductive brick of the E-TESS system according to an aspect of this disclosure.

FIG. 4 provides a perspective view of an exemplary electrically insulative brick of the E-TESS system according to an aspect of this disclosure.

FIG. 5 provides a cross-sectional view of an exemplary E-TESS system, according to an aspect of this disclosure, depicting a circuit of electrically conductive brick connected to input and output electrodes.

FIG. 6 shows an embodiment of a solid cylindrical E-Brick within a hollow core region of circular I-Brick, according to an aspect of this disclosure.

FIG. 7 shows perspective view of an embodiment of a double-cylinder I-Brick according to an aspect of this disclosure.

FIG. 8 shows perspective view of a cylindrical E-Brick according to an aspect of this disclosure.

FIG. 9 shows an embodiment of two columns of cylindrical E-Bricks using a double-cylinder end connector, according to an aspect of this disclosure.

FIG. 10 shows a perspective view of the double-cylinder end connector, of FIG. 9.

FIG. 11 is a schematic showing the cross-brick of FIG. 10 transitioning from a circular to a obround cross section.

FIG. 12 is an illustration of the development of the cross-brick design of FIG. 10 configured to be seated on a surface from a U-shaped concept, of FIG. 10.

FIG. 13 is a schematic of the electrically conductive cross-brick design of FIG. 10, of FIG. 10.

FIG. 14 shows a 3D model of a finite element analysis simulation of the cross-brick geometry of FIG. 10, including the relevant thermal-electric boundary condition assumptions.

FIG. 15 shows the resulting current density of a finite element analysis simulation of the cross-brick geometry of FIG. 10.

FIG. 16A shows a first embodiment of a cross-brick having a flared lower lateral portion for added stability, according to an aspect of this disclosure. FIG. 16B shows another embodiment of a cross-brick having a flared lateral portion for added stability, according to an aspect of this disclosure. FIG. 16C shows yet another embodiment of a cross-brick having a flared lateral portion for added stability, according to an aspect of this disclosure. A cross-brick having such a stability improvement design may be referred to as a “flared cross-brick.”

FIG. 17A shows one embodiment of a bottom of a flared cross-brick that reduces center high points, according to an aspect of this disclosure. FIG. 17B shows another embodiment of a bottom of a flared cross-brick that reduces center high points, according to an aspect of this disclosure. FIG. 17C shows yet another embodiment of a bottom of a flared cross-brick that is flat, according to an aspect of this disclosure.

### DETAILED DESCRIPTION OF SPECIFIC EMBODIMENTS

The disclosure and the various features and advantageous details thereof are explained more fully with reference to the non-limiting embodiments and examples that are described and/or illustrated in the accompanying drawings and detailed in the following description. Various aspects of the subject matter discussed in greater detail below may be implemented in numerous ways, as the subject matter is not limited to any particular manner of implementation. Examples of specific implementations and applications are provided primarily for illustrative purposes.

Unless otherwise defined, used, or characterized herein, terms that are used herein (including technical and scientific terms) are to be interpreted as having a meaning that is consistent with their accepted meaning in the context of the relevant art and are not to be interpreted in an idealized or overly formal sense unless expressly so defined herein. The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms “includes,” “including,” “comprises,” and “comprising” specify the presence of the stated elements or steps but does not preclude the presence or additional of one or more other elements or steps.

Embodiments described herein may comprise, or make use of, electrically conductive (and thermally conductive) bricks (“E-bricks”). E-bricks generate heat when a current is run through them via direct resistance heating (DRH). E-bricks may be capable of reaching very high temperatures, such as 1000° C. to 2000° C. or higher and reliably cycling between a predetermined temperature range (e.g. ˜1000° C. to ˜1800° C.) on a daily basis. E-bricks may be stacked, e.g., into columns that are physically and electrically coupled, and arranged into a large structure, a thermal energy storage system (“TESS”) (a.k.a. an electrically heated thermal energy storage system E-TESS). Examples of E-bricks and E-TESS's may be found in U.S. Pat. No. 11,877,376, U.S. Publication No. US2025/0052516, and U.S. Publication No. 2025/0047225, the contents of each of which are hereby incorporated, in full, by reference. Embodiments of E-TESS's may be used, for example, in various industrial and chemical processes that generate and/or consume heat, such as furnaces, kilns, refineries, power plants, allowing these processes to significantly reduce or eliminate burning of fossil fuels.

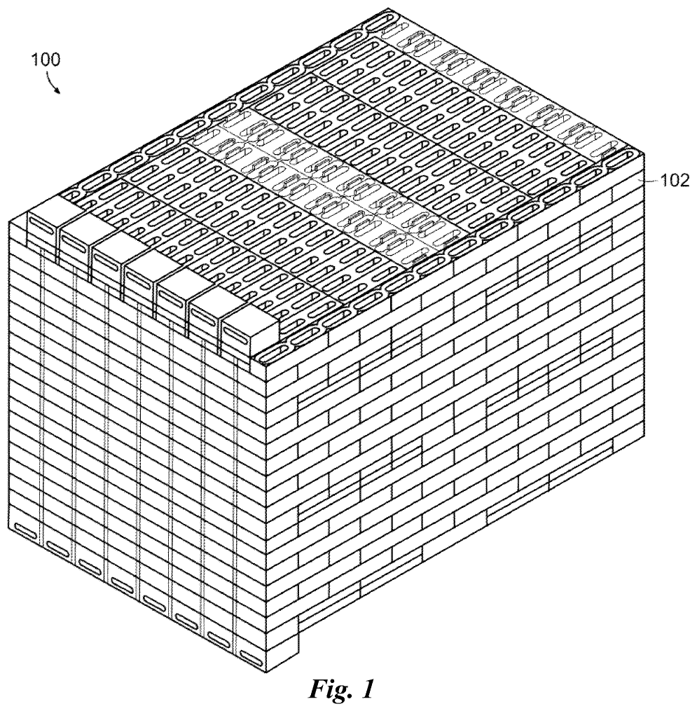

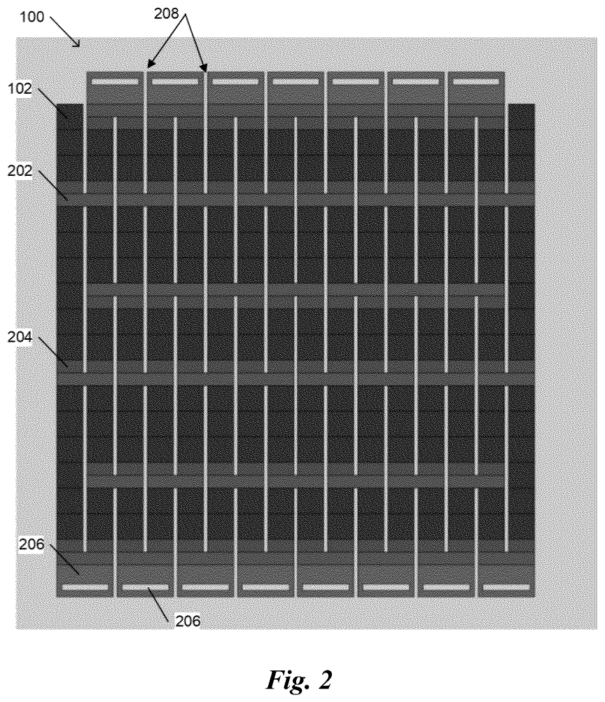

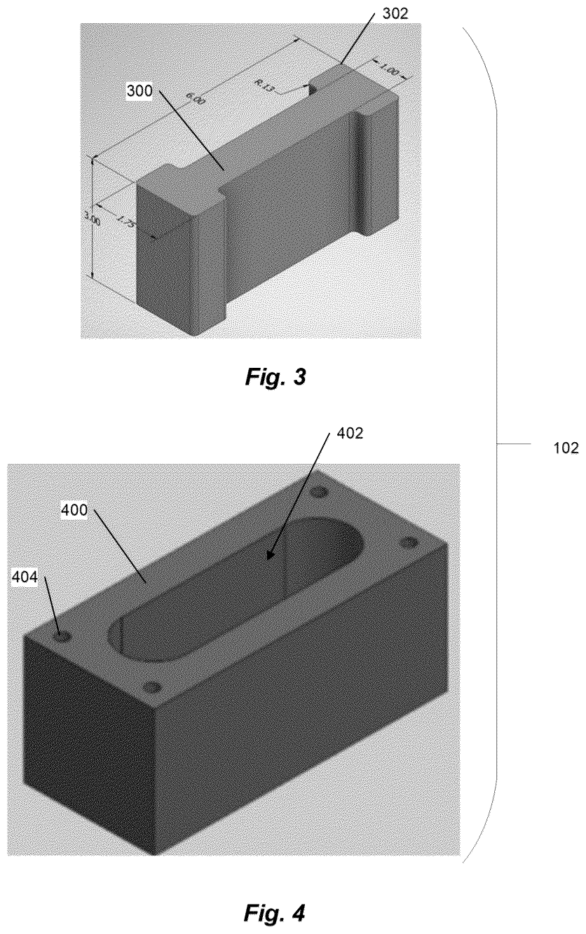

FIG. 1 shows an exemplary embodiment of an E-TESS module 100, which is primarily composed of a large quantity of electrically and thermally conductive brick assemblies 102 (“E-brick assemblies”). The E-brick assembly 102 may comprise an electrically conductive brick 300 (“E-brick”), FIG. 3, contained within an electrically insulating (but thermally conductive) brick 400 (“I-brick”), FIG. 4. In some embodiments there may be more than one E-brick contained within an I-brick, or there may be a plurality of I-bricks that, in combination, provide insulation to one or more E-bricks. In FIGS. 1 and 2, only the I-bricks of the E-brick assemblies 102 are visible, as the E-bricks are contained in an internal region within the I-brick as shown in FIG. 4 and described below. The E-bricks in each column are physically in contact with each other and physically connected to the E-bricks in adjacent columns to form one contiguous electrical circuit when a voltage is applied across the E-TESS module 100, thereby causing an electric current to flow through the electrical circuit formed by the E-bricks.

The E-TESS module 100 generates a large amount of thermal energy when an electrical current is run through the contiguous circuit of E-bricks. The thermal energy may be stored in the E-bricks/I-bricks for extended periods of time (e.g., up to 24 hours). The thermal energy may be harvested immediately, or after it has been stored, by flowing a fluid, e.g., a gas, such as air or CO₂, through E-TESS module 100. The thermal energy in the E-bricks is transferred to the I-bricks and flow paths or channels (shown in FIG. 2) between the columns of E-brick assemblies 102 allow the fluid to flow through the E-TESS module 100. This application may henceforth refer to fluid, gas, or air flowing through the flow paths or channels of E-TESS module 100, but it should be noted that these terms may be used interchangeably herein and are intended to have the same meaning. Moreover, any suitable fluid, such as air or CO₂, may be used to extract the heat from E-TESS module 100. Additionally, some bricks are left out of the view in FIG. 1 to provide easier viewing.

FIG. 2 shows a side view of an embodiment of E-TESS module 100. The E-TESS module 100 comprises a large quantity of E-brick assemblies 102, arranged in a plurality of adjacent columns, which are physically and electrically interconnected in a serpentine fashion to form a contiguous circuit. The E-brick assemblies 102 may, in large part, be conductive only in the vertical direction (i.e., along the length of the columns), and electrically externally insulated in all other directions by the I-bricks, such that current follows the serpentine circuit (via the connected E-bricks) and does not arc between columns of E-brick assemblies 102, when there is a potential difference between the columns, e.g. in a case where different phases power are being run through adjacent columns.

Between columns there are flow paths or channels 208, through which air may flow (in the direction into or out of the page) in order to extract or harvest the thermal energy generated by the E-bricks to be used to a heat load. By flowing the air through the flow paths 208 the heat may be extracted from the E-TESS module 100 without having the air contact the E-bricks directly. This is especially useful because if the E-bricks comprise Cr₂O₃ and are exposed to the flowing air directly, then the Cr₂O₃ tends to volatilize, which erodes the brick electrical performance over time, and also produces a toxic gas, CrO₃, which must be kept below regulated levels and as low as possible.

Current may enter the E-TESS module 100, for example, through a cable (not shown) connected to the top left corner (from the perspective of FIG. 2) and may exit the E-TESS 100 through a cable (not shown) connected to the top right corner. In addition to the E-brick assemblies 102, there may be other bricks, such as double-wide bricks 202, thin bricks 204, and end connector bricks 206 used in the E-TESS module 100.

Double-wide bricks 202 provide horizontal stabilization between columns of E-brick assemblies 102, and structural integrity of the E-TESS module 100. Double-wide bricks 202 are insulated such that current can flow vertically within columns but does not flow across them between columns. Double-wide bricks 202 may be thinner (i.e., have a lower height) than E-brick assemblies 102, because double-wide bricks 202 span the gaps 208 between columns, and therefore partially obstruct the airflow through the gaps 208. Double-wide bricks 202 may, for example, be half the height of an E-brick assembly 102.

Thin bricks 204 are single-wide, like an E-brick assembly 102, but thinner, i.e., have a lower height than an E-brick assembly 102. Thin bricks 204 may, for example, be half the height of an E-brick assembly 102. Thin bricks 204 may be used in conjunction with double-wide bricks 202 such that the height of the double-wide brick 202 and thin brick 204 stack is equal to the height of an E-brick assembly 102. Thin bricks 204 may also be used in place of a double-wide brick 202 to maintain even levels of bricks in situations where a double-wide brick 202 is not desirable in at least one column, e.g., due to its obstructing effect on airflow, but is desirable in another column of that level.

End connector bricks 206 connect columns of bricks together, both physically and electrically. End connector bricks 206 act as end caps to columns of bricks and contain within them E-bricks which may be of a different shape that those contained in the E-brick assemblies 102 to physically and electrically connect the E-Bricks from one column of E-brick assemblies 102 to an adjacent column of E-brick assemblies 102. Current may, for example, flow down one column of bricks, perform a “U-turn” through an end connector brick 206, and then flow up the adjacent column, until it reaches the next end connector brick 206, wherein it will perform another “U-turn”, and continue in that fashion. End connector bricks may have channels or cutouts though which air may flow. End connector bricks 206 may typically have a flat bottom (or top, depending on its orientation).

FIG. 3 shows a specific embodiment of an electrically conductive brick 300 (“E-brick”). As described above, E-bricks 300 may be configured to stack vertically with each other, which creates a part of a conductive circuit through which current and heat may flow. E-bricks 300 may be formed in many different shapes, including cross-sectional shapes of circles, rectangles, squares, or crosses, for example. FIG. 3 shows an example of a “dog bone” shaped E-brick. The E-brick 300 may have rounded or chamfered corners 302.

Referring also to FIG. 4, an E-brick 300 is configured to fit within an electrically insulating brick 400 (“I-brick”). I-brick 400 may have a hollow internal region 402, in which an E-brick 300 may fit. An E-brick assembly 102 may comprise an E-brick 300 inside of an I-brick 400. Based on the E-brick design, the exterior shape of the I-brick and the shape of the hollow internal region 402 may have differing shapes. Other bricks may also comprise an E-brick inside of an I-brick. The hollow 402 may extend through the height of the I-brick 400 so that the E-brick 300 may conductively connect with the E-bricks above and below.

Some I-brick embodiments may comprise multiple hollows, such as a double-length I-brick with two collinear hollows, each capable of housing an E-brick. The relative sizes of the E-brick 300 and I-brick 400 may be such that there are several millimeters of clearance between the exterior sides of the E-brick and the interior sides of the I-brick hollow. For example, there may be 1, 2, 5, 7, or 10 mm of clearance. The clearance allows thermal expansion to occur at different rates between the E-brick 300 and I-brick 400, due to material and temperature differences, and reduces friction damage between the E-brick 300 and I-brick 400. The rounded corners 302 also help reduce friction damage. Other bricks may have a hollow similar to hollow 402. I-bricks may comprise pin holes 404, in which pins or rods may be placed in order to align stacks of bricks. I-bricks 400 may be made in different shapes, both of the external sides and the internal hollow 402.

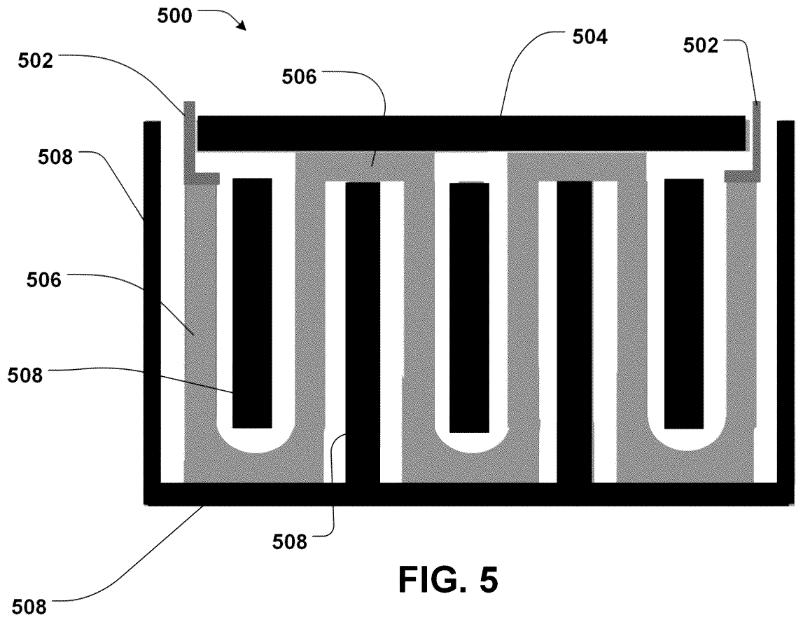

FIG. 5 shows a cross-sectional view of an embodiment of an electrically conductive brickwork module 500 according to the present disclosure. In this embodiment, electrodes 502, which are electrically connected by means of an external current source (not shown) pass through an insulating cover 504 into the electrically conductive brickwork module 500, thereby making contact with a serpentine circuit of E-bricks 506, which are resistively heated as current passes through them from electrodes 502. The E-bricks 506 transfer heat to the thermal I-bricks 508, thereby providing an efficient thermal energy storage mechanism.

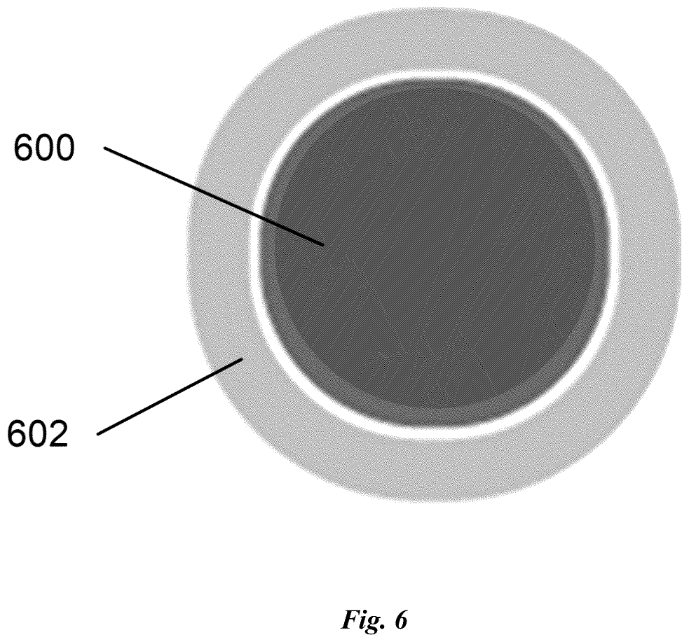

E-Bricks and I-Bricks may be provided in various shapes, such as cylinders. FIG. 6 shows an embodiment of a solid cylindrical E-Brick 600, within a hollow core region of circular I-Brick 602.

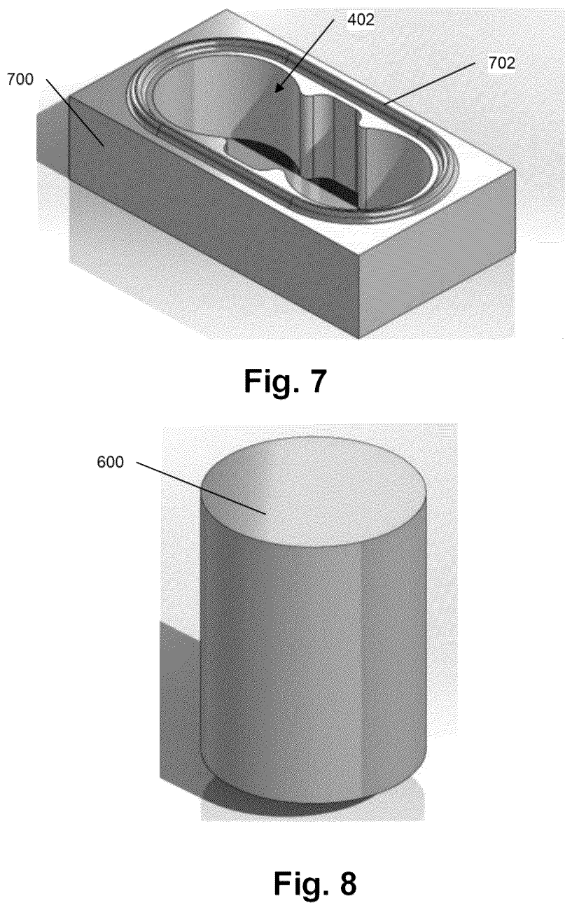

FIG. 7 shows an embodiment of a double-cylinder I-Brick 700, which has a hollow 402 configured to fit two solid cylindrical E-Bricks 600. The double-cylinder I-Brick 700 may also have a protruding ring 702 around the hollow 402.

The hollow interior region of the Double-cylinder I-Brick has an interior surface defined by the hollow interior region and the interior surface includes a first semi-circular section and a second semi-circular section opposite the first semi-circular section. Each of the first semi-circular section and the second semi-circular section are configured to receive an electrically conductive brick having a circular cross-sectional shape.

FIG. 8 shows a perspective view of an embodiment of a solid cylindrical E-Brick 600.

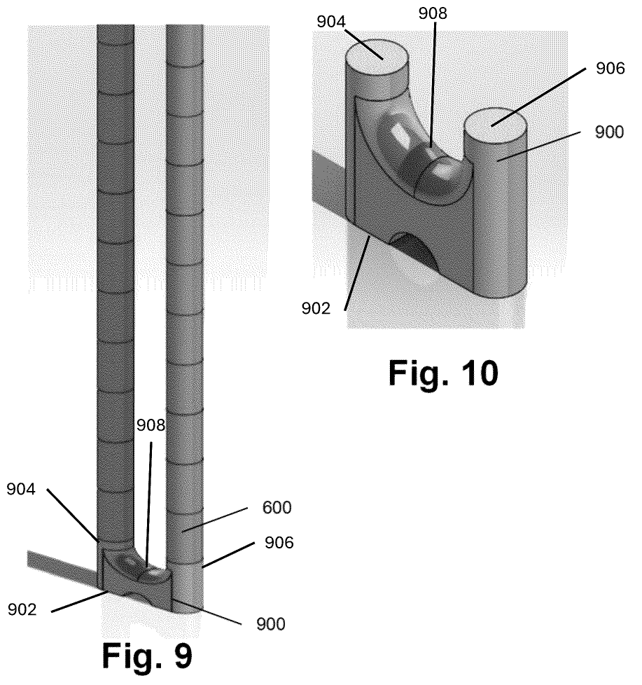

FIG. 9 shows an embodiment of two columns of cylindrical E-Bricks 600 which may be contained in a plurality of vertically stacked I-Bricks 700, FIG. 7. There is shown an embodiment of a double-cylinder end firebrick connector (a “cross-brick”) 900, which electrically connects the two columns, and has a substantially flat base configured for standing. The cross-brick has a base 902 having a bottom surface configured to support the firebrick connector when placed on a flat surface. A first cylindrical protrusion 904 comprising electrically conductive firebrick material extends away from the base on a first lateral side of the base and may be configured to be connected to a cylindrically shaped firebrick. In addition, a second cylindrical protrusion 906 comprising electrically conductive firebrick material extends away from the base on a second lateral side of the base and may be configured to be connected to a cylindrically shaped firebrick. Each of the first and second cylindrical protrusions are connected to each other by a concave electrically conductive firebrick structure 908 forming part of the base. Here, the bottom surface of the cross-brick includes a centrally located arched portion extending into the base relative to the bottom surface.

As used herein, a “conductive firebrick connector” is a “cross-brick.” A cross-brick has a relatively flat base and electrically and physically connects two cylindrical columns of E-bricks. In some embodiments, a cross-brick connects two parallel columns of cylindrical E-bricks, wherein the E-bricks of each column of mortared together. In other embodiments, the cylindrical protrusions of a cross-brick form a contiguous structure of two parallel cylindrical columns of electrically conductive firebrick material. Each of the parallel columns may form an entire E-brick column or may, independently of each other, be connected to additional cylindrical E-bricks.

FIG. 10 shows an individual view of cross-brick 900.

In creating larger structures comprising columns of E-bricks, there is need to effectively physically and electrically couple a given column of the larger structure to another column of the structure. Here, we disclose a cross-brick based on a U-shaped design configured to physically and electrically couple two columns of cylindrical E-Bricks, the cross-brick having an obround cross-section that transitions into two circular cross-section.

Aspects of the cross-brick design disclosed herein have many advantages, providing a component for physically and electrically connecting two columns of cylindrical E-Bricks that does not involve a complicated manufacturing process (the cross-bricks can be pressed into their desired shape).

Although a cross-brick may take any shape, the cross-brick embodiments disclosed herein based on a U-shaped design do not have sharp corners or edges, thereby avoiding unwanted current density peaks. Moreover, the cross-brick embodiments disclosed herein prioritize the smoothness of electric flow first, rather than other aspects, such as the ability to be seated on a surface and remain upright. The rounded design of the cross-brick embodiments disclosed herein also helps reduce stresses at the surface of the cross-brick

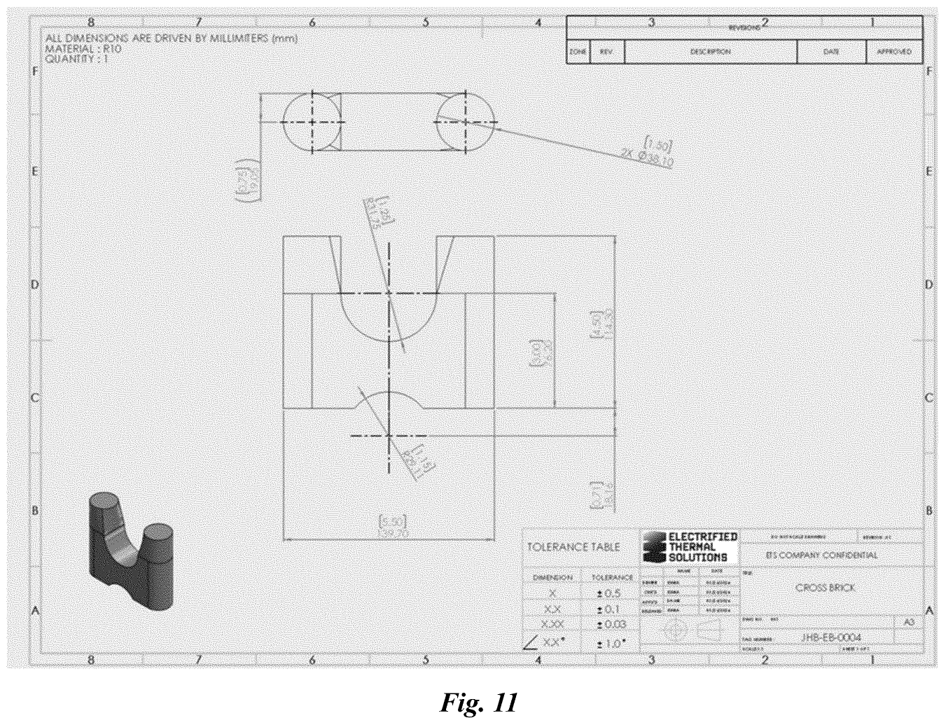

In considering different types of E-Brick designs, a cylindrical E-Brick was considered and as a result a new cross-brick design was developed to physically and electrically connect two columns of cylindrical E-Bricks using a obround cross-section to circular cross-section transition in the cross-brick as shown in FIGS. 9, 10, 11, 12, and 13.

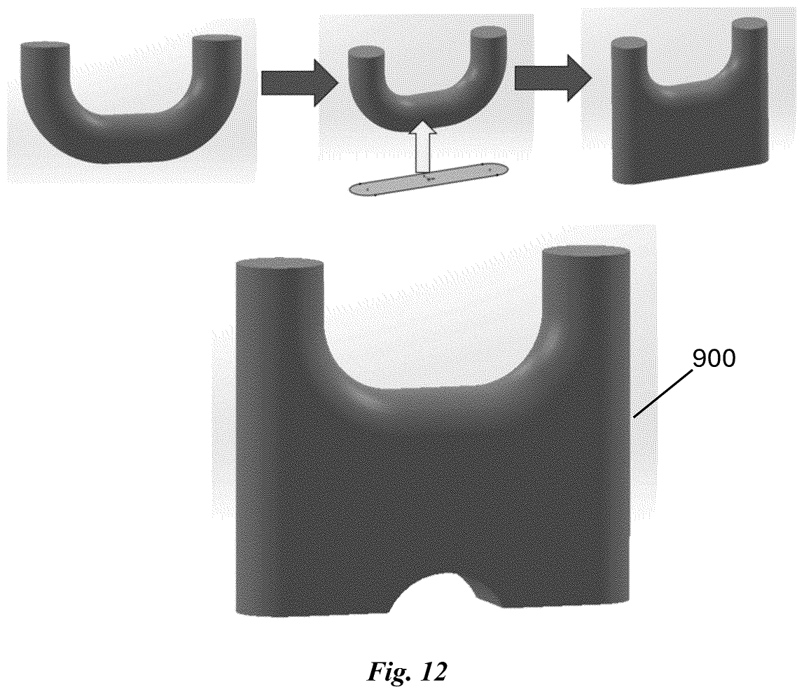

FIG. 12 shows the cross-brick design originates from a U-shaped concept since electric current travels like a flow. A matching solid volume was added to a U-shaped volume for it to be seated on the ground, while maintaining the curvature and matching or exceeding the cross-sectional flow area of the U-shaped design so that, inherently, there are no sharp transitions or geometric bottlenecks.

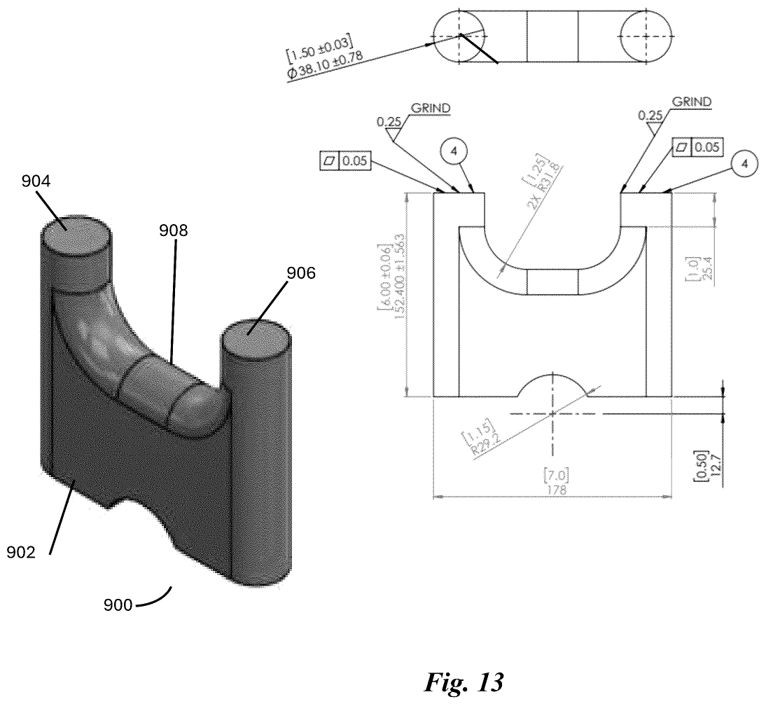

FIG. 13 shows a schematic of an electrically conductive cross-brick design.

The cross-brick 900 has a base 902 having a bottom surface configured to support the firebrick connector when placed on a flat surface. A first cylindrical protrusion 904 comprising electrically conductive firebrick material extends away from the base on a first lateral side of the base and may be configured to be connected to a cylindrically shaped firebrick. In addition, a second cylindrical protrusion 906 comprising electrically conductive firebrick material extends away from the base on a second lateral side of the base and may be configured to be connected to a cylindrically shaped firebrick. Each of the first and second cylindrical protrusions are connected to each other by a concave electrically conductive firebrick structure 908 forming part of the base. Here, the bottom surface of the cross-brick includes a centrally located arched portion extending into the base relative to the bottom surface.

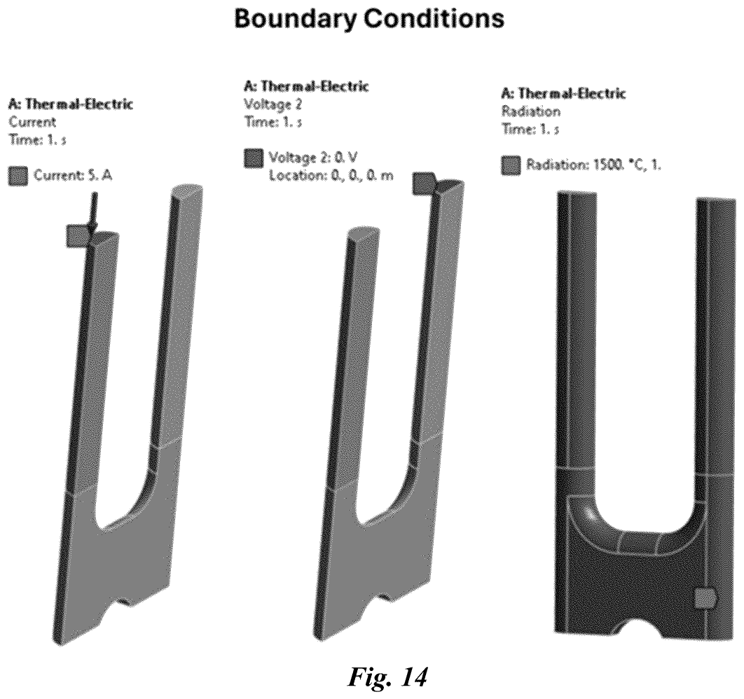

Finite element analysis was conducted to demonstrate the performance of the new cross-brick design with respect to electric current uniformity at a representative operating condition. 10″ electrically conductive cylindrical legs were considered to give enough upstream and downstream space for electric flow before and after the portion of sideways electrical flow. A half-volume model of the cross-brick was considered with appropriate symmetry boundary conditions in the middle to reduce simulation time. FIG. 14 shows the geometry of the 3D model, and the relevant thermal-electric boundary conditions. The body was simulated with a steady state 5 Amp electrical current applied to the cross section of one cylindrical leg, a zero-voltage boundary condition on the opposite cylindrical leg, and a radiative heat transfer condition with at 1500° C. prescribed surface.

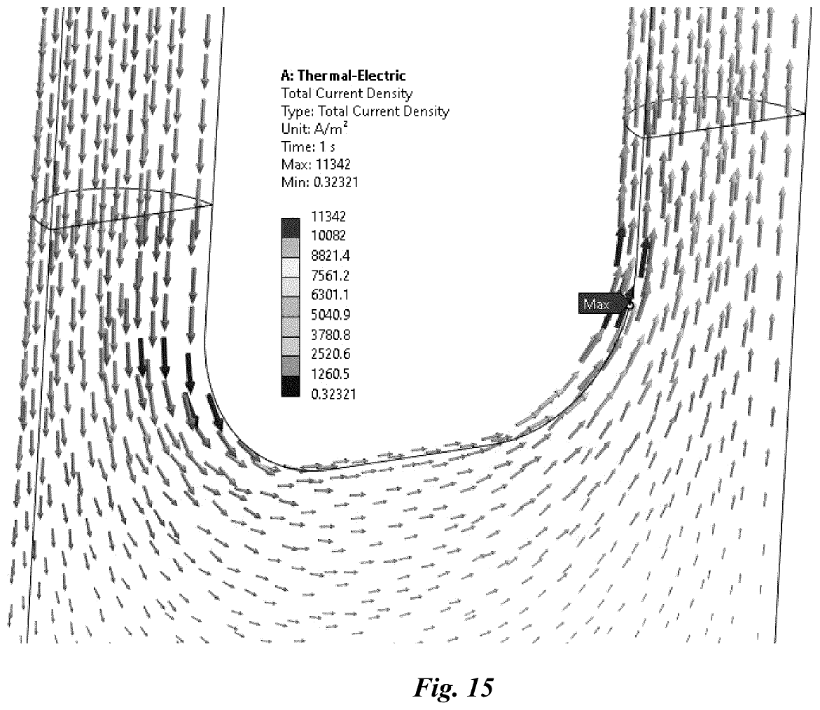

FIG. 15 shows the results of steady state thermal-electric finite element analysis and demonstrates that electric current does not generate unnecessary peaks due to the transition from circular to obround cross sections, as desired. In general, the electric current density follows the smooth transition and only peaks at the expected rounded corners. The flow chooses the path with the least resistance and not the shortest path. Therefore, the peak density results do not show high density line at the apex of U-shape.

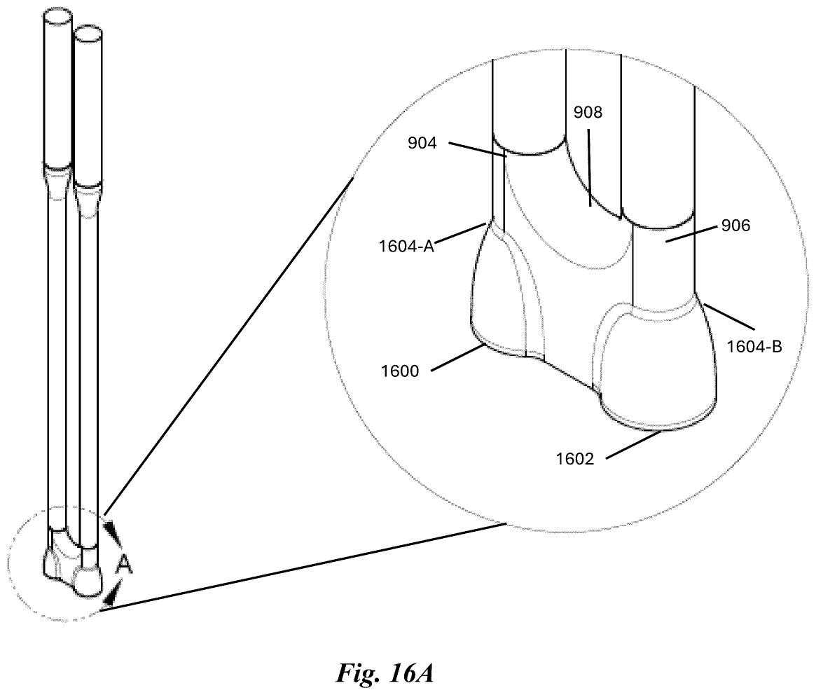

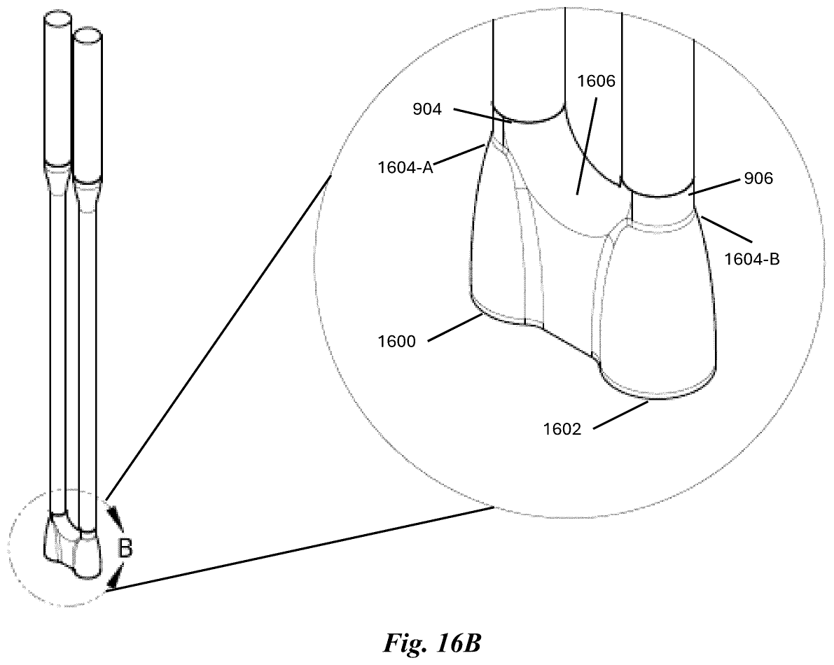

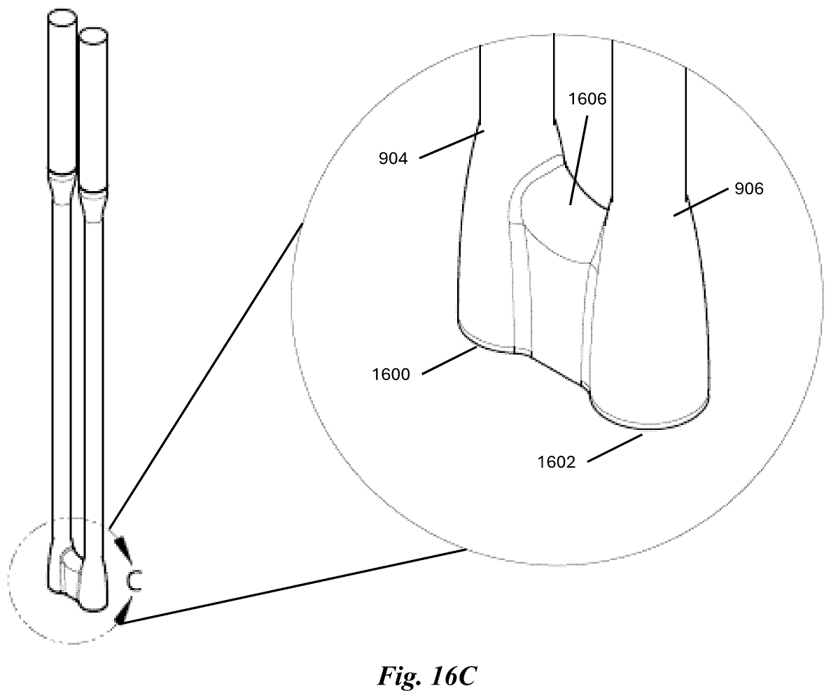

In some aspects, it is preferred that a cross-brick has a wider footprint at its base to improve the stability of the cross-brick. FIGS. 16A-C show non-limiting examples of cross-brick designs having a “flared” (widened) base. FIG. 16A shows a first embodiment of a cross-brick having a flared lower lateral portion for added stability. Here, the bottom surface of the cross-brick includes a first cylinder-shaped footing 1600 on the first lateral side of the base and a second cylinder-shaped footing 1602 on the second lateral side of the base. The first footing and the second footing extend away from the base in a direction opposite the first and second cylindrical protrusions. The first cylinder-shaped footing and the second cylinder-shaped footing each having a first end (1604-A, 1604-B) located at a position on the base proximate the concave electrically conductive firebrick structure. The first ends of the first and second cylinder-shaped footing each extend laterally away from the base and are flared along their lengths from the first ends to their second ends, terminating proximate the bottom surface of the firebrick. FIG. 16B shows another embodiment of a cross-brick having a flared lateral portion for added stability. The embodiment of FIG. 16B is similar to that of FIG. 16A but the first ends of the first cylinder-shaped footing 1600 and the second cylinder-shaped footing 1602 are located at a position on the base proximate to the concave electrically conductive firebrick structure, ending near the bottom of the U-shape 1606. FIG. 16C shows yet another embodiment of a cross-brick having a flared lateral portion for added stability. Here, the first ends of the first cylinder-shaped footing 1600 and the second cylinder-shaped footing 1602 extend past bottom of U-shape 1606 and include first and second cylindrical protrusions 904 and 906, respectively. A cross-brick having such a stability improvement design may be referred to as a “flared cross-brick.”

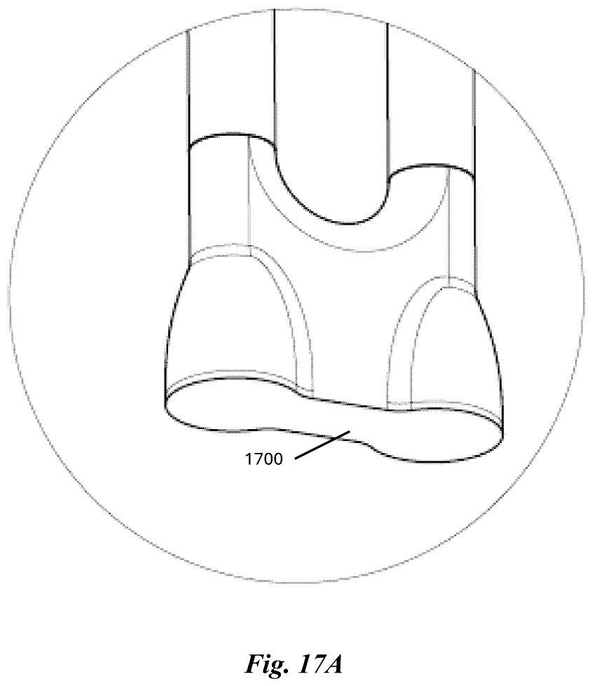

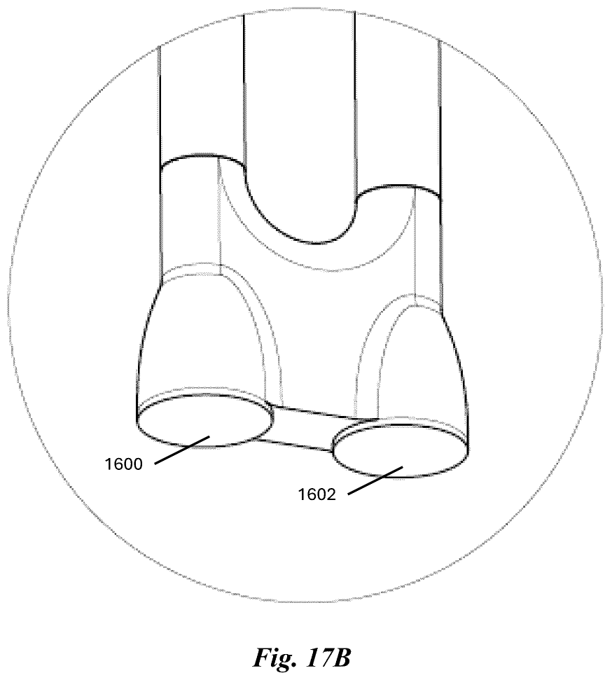

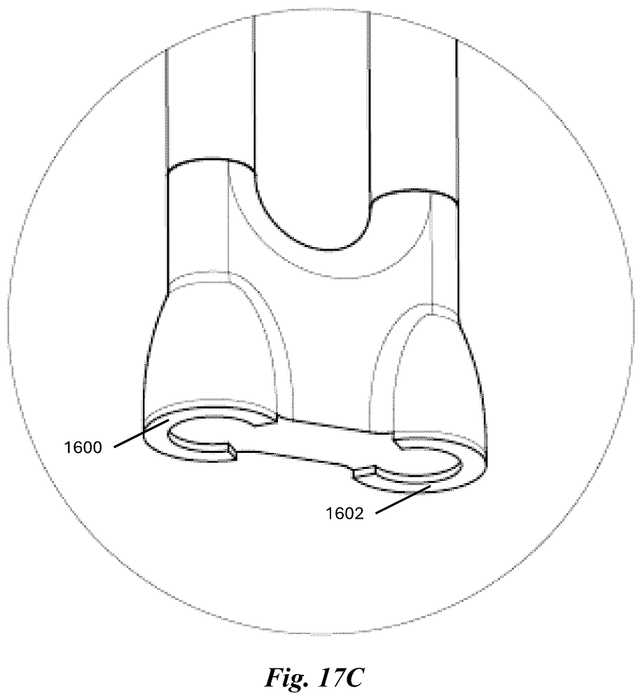

In some aspects, the disclosure provides various, non-limiting, designs for a bottom of a cross-brick. For example, FIG. 17A shows one embodiment of a bottom surface of the flared cross-brick of FIG. 16A where the bottom is flat. FIG. 17B shows another embodiment of the bottom surface 1700 of the flared cross-brick of FIG. 16A that reduces center high points. Here, the bottom surface of the cross-brick includes a first cylinder-shaped footing 1600 on the first lateral side of the base and a second cylinder-shaped footing 1602 on the second lateral side of the base. FIG. 17C shows yet another embodiment of the bottom surface of the flared cross-brick of FIG. 16A. Here, the shape of the second ends of first cylinder shaped footing and the second cylinder shaped footing are approximately semi-circular in shape.

Various embodiments of the present invention may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:
P1. An electrically conductive firebrick connector comprising:
   a base having a flat bottom surface configured to support the firebrick connector when placed on a flat surface;
   a first cylindrical protrusion having a first end extending upward from the base on a first lateral side of the base and a second end configured to be connected to a cylindrically shaped firebrick;
   a second cylindrical protrusion having a first end extending upward from the base on a second lateral side of the base and a second end configured to be connected to a cylindrically shaped firebrick;
   wherein the first and second cylindrical protrusions comprise an electrically conductive firebrick material and wherein the first and second cylindrical protrusions are connected to each other by a concave electrically conductive firebrick structure forming part of the base.
P2. An electrically conductive firebrick connector comprising:
   a base having a bottom surface configured to support the firebrick connector when placed on a flat surface;
   a first cylindrical protrusion having a first end extending away from the base on a first lateral side of the base and a second end configured to be connected to a cylindrically shaped firebrick; wherein the first cylindrical protrusion comprises an electrically conductive firebrick material; and
   a second cylindrical protrusion having a first end extending away from the base on a second lateral side of the base and a second end configured to be connected to another cylindrically shaped firebrick; wherein the second cylindrical protrusion comprises an electrically conductive firebrick material;
   wherein the first and second cylindrical protrusions are connected to each other by a concave electrically conductive firebrick structure forming part of the base.
P3. The electrically conductive firebrick connector according to any one of potential claims P1-P2, wherein the concave electrically conductive firebrick structure and the first and second cylindrical protrusions form a U-shape.
P4. The electrically conductive firebrick connector according to any one of potential claims P1-P3, wherein the entire connector is formed of electrically conductive firebrick material.
P5. The electrically conductive firebrick connector according to any one of potential claims P1-P4, wherein a cross-section of the base parallel to the bottom surface is obround.
P6. The electrically conductive firebrick connector according to any one of potential claims P1-P5, wherein the bottom surface includes a centrally located arched portion extending into the base relative to the bottom surface.
P7. The electrically conductive firebrick connector according to any one of potential claims P1-P6, wherein the bottom surface is substantially flat.
P8. The electrically conductive firebrick connector according to any one of potential claims P1-P7, wherein the bottom surface is obround shaped.
P9. The electrically conductive firebrick connector of potential claim P8, wherein the bottom surface includes an indented surface portion.
P10. The electrically conductive firebrick connector of potential claim P9, wherein the indented surface portion is oval-shaped.
P11. The electrically conductive firebrick connector according to any one of potential claims P7-P10, wherein the bottom surface includes a first cylinder-shaped footing on the first lateral side of the base and a second cylinder-shaped footing on the second lateral side of the base; and wherein the first footing and the second footing extend away from the base in a direction opposite the first and second cylindrical protrusions.
P12. The electrically conductive firebrick connector of potential claim P11, wherein the first cylinder-shaped footing and the second cylinder-shaped footing each has a first end located at a position on the base proximate the concave electrically conductive firebrick structure; and wherein the first ends of the first and second cylinder-shaped footing each extend laterally away from the base and are flared along their lengths from the first ends to their second ends terminating proximate the bottom surface.
P13. The electrically conductive firebrick connector of potential claim P12, wherein the shape of the second ends of the first cylinder-shaped footing and the second cylinder-shaped footing are one of (a) circular in shape or (b) form a major arc of a circle.
P14. The electrically conductive firebrick connector of potential claim P13, wherein the second ends of first cylinder shaped footing and the second cylinder shaped footing are one of (i) flush with the bottom surface or (ii) extend away from the bottom surface in a direction opposite the first and second cylindrical protrusions.

What is claimed is:

1. An electrically conductive firebrick connector comprising:
a base having a bottom surface configured to support the firebrick connector when placed on a flat surface;
a first cylindrical protrusion having a first end extending away from the base on a first lateral side of the base and a second end configured to be connected to a cylindrically shaped firebrick; wherein the first cylindrical protrusion comprises an electrically conductive firebrick material; and
a second cylindrical protrusion having a first end extending away from the base on a second lateral side of the base and a second end configured to be connected to another cylindrically shaped firebrick; wherein the second cylindrical protrusion comprises an electrically conductive firebrick material;
wherein the first and second cylindrical protrusions are connected to each other by a concave electrically conductive firebrick structure forming part of the base.

2. The electrically conductive firebrick connector of claim 1, wherein the concave electrically conductive firebrick structure and the first and second cylindrical protrusions form a U-shape.

3. The electrically conductive firebrick connector of claim 1, wherein the entire connector is formed of electrically conductive firebrick material.

4. The electrically conductive firebrick connector of claim 1, wherein a cross-section of the base parallel to the bottom surface is obround.

5. The electrically conductive firebrick connector of claim 1, wherein the bottom surface includes a centrally located arched portion extending into the base relative to the bottom surface.

6. The electrically conductive firebrick connector of claim 1, wherein the bottom surface is substantially flat.

7. The electrically conductive firebrick connector of claim 1, wherein the bottom surface is obround shaped.

8. The electrically conductive firebrick connector of claim 7, wherein the bottom surface includes an indented surface portion.

9. The electrically conductive firebrick connector of claim 8, wherein the indented surface portion is oval-shaped.

10. The electrically conductive firebrick connector of claim 6, wherein the bottom surface includes a first cylinder-shaped footing on the first lateral side of the base and a second cylinder-shaped footing on the second lateral side of the base; and wherein the first footing and the second footing extend away from the base in a direction opposite the first and second cylindrical protrusions.

11. The electrically conductive firebrick connector of claim 10, wherein the first cylinder-shaped footing and the second cylinder-shaped footing each has a first end located at a position on the base proximate the concave electrically conductive firebrick structure; and wherein the first ends of the first and second cylinder-shaped footing each extend laterally away from the base and are flared along their lengths from the first ends to their second ends terminating proximate the bottom surface.

12. The electrically conductive firebrick connector of claim 11, wherein the shape of the second ends of the first cylinder-shaped footing and the second cylinder-shaped footing are one of (a) circular in shape or (b) form a major arc of a circle.

13. The electrically conductive firebrick connector of claim 12, wherein the second ends of first cylinder shaped footing and the second cylinder shaped footing are one of (i) flush with the bottom surface or (ii) extend away from the bottom surface in a direction opposite the first and second cylindrical protrusions.
